(19) United States
(12) Patent Application Publication
(10) Pub. No.: US 2009/0175031 A1
(43) Pub. Date: Jul. 9, 2009

(54) PEOPLE CONVEYOR LIGHTING

(76) Inventors: Dirk Winkelhake, Bolton, CT (US); Juergen Kuhlmann, Poysdorf (AT)

Correspondence Address: CARLSON GASKEY & OLDS, 400 W MAPLE STE 350, BIRMINGHAM, MI, 48009, US

(21) Appl. No.: 12/301,239

(22) PCT Filed: May 19, 2006
(86) PCT No.: PCT/EP06/04778

§ 371 Date: Nov. 18, 2008

(51) Int. Cl. F21S 8/00; B66B 23/22

(52) U.S. Cl. 362/146

(57) ABSTRACT

People conveyor (2) having an endless people transportation band (4) and an endless handrail (6), a device ( ) for determining the speed of the transportation band (4) and/or the endless handrail (6), an illumination means (50, 52) extending along the transportation band (4) and comprising a plurality of illumination sources (51), and an illumination control device (28) connected to the illumination sources (51), wherein the illumination control device is adapted to effect illumination of individual illumination sources (51) dependent of the speed of the transportation band (4) and/or the handrail (6).

The present invention relates to a people conveyor having an endless people transportation band and an endless handrail, an illumination means extending along the transportation band and comprising a plurality of illumination sources.

A people conveyor of this type is known from DE 19 957 680 A1. Particularly, the people conveyor can be an escalator or moving walkway. Accordingly, the endless transportation band can comprise a plurality of individual steps or pallets which are arranged one after the other so as to form the endless revolving transportation band. Alternatively, an elastic endless belt can form the transportation band. The handrail is preferably moveable together with the endless people transportation band so as to move in unison therewith.

For various reasons, it is preferred to illuminate at least portions of the escalator. Thus it is preferred for security reasons to illuminate the transportation band particularly next to the entrance area and the exit area of the transportation band. Such illumination means can be located at the inner decking which boarders the transportation band laterally, in the balustrade which extends upwardly from the inner decking, and in a profile on top of the balustrade which supports and guides the handrail.

Glass balustrades are becoming more and more popular with people conveyors of this type. “Glass balustrade” in the context of the present application refers to balustrade made of transparent or translucent material which does not necessarily have to be glass. The illumination means can also arranged along the side or any of the longitudinal edges of the balustrade so as to radiate into the glass balustrade.

The problems with such illumination means is that they are static, i.e. they do not draw attention to locations of particular interest of the people conveyor, etc. Thus, it is the object of the present invention to provide a people conveyor with an illumination means which is adapted to attract particular attention to the whole or portions of the people conveyor.

In accordance with the present invention, this object is solved by a people conveyor having an endless people transportation band and endless handrail, a device for determining the speed of the transportation band and/or the endless handrail, an illumination means extending along the transportation band and comprising a plurality of illumination sources, and an illumination control device connected to the illumination sources, wherein the illumination control device is adapted to effect illumination of individual illumination sources dependent of the speed of the transportation band and/or the handrail.

With a people conveyor having an illumination means of this type, it is possible to have the illumination follow the movement of the transportation band with the same speed as that of the transportation band—and the handrail which moves approximately with the same speed as the transportation band—or with a speed in a specific relation to the speed of a transportation band. Thus, one might contemplate to have the moving speed of the illumination to be twice the speed of the transportation band or three times thereof or any other preselected speed relationship. With the invention, the illumination means does not necessarily extend along the complete transportation band. The illumination means can also extend beyond the complete length of the transportation band, for example into the entry area at the entrance and exit landings.

The illumination effect as caused by the illumination of individual illumination sources dependent on the speed of the transportation band does not necessarily have to move along the complete length of the illumination means but can be limited to a particular portion thereof, only. Moreover, it is not necessary that this illumination effect actually moves along the illumination means and the transportation band, respectively. It is also possible to have any other optical effect, for example change of intensity, on-off, etc. with a particular rhythm as determined by the speed of the transportation band. As such, it is possible to flash the illumination means at the exit landing or entry landing whenever a step or pallet starts to move under the combplate or starts to emerge from the combplate thus giving to the user a rhythm facilitating the transition from the moving pallet or step to the stationary landing and vice versa.

The illumination control device can be adapted to effect illumination of individual illumination sources so that an “illumination gap” travels along the illumination means together with the transportation band. The illumination gap can be a dark gap, i.e. a region within the illumination means where the individual light sources are not lighting but are dark. Such gap can move with the same speed as the transportation band, can also move with the double speed thereof or a fraction thereof or any speed related to the speed of the transportation band. Instead of the “illumination gap”, the opposite, i.e. an “illumination spot”, can travel together with the transportation band.

The people conveyor may further comprise a passenger detecting device which is connected to the illumination control and therein the illumination control is adapted to effect illumination of the individual illumination sources so that an illuminated portion or “illuminated spot” of the illumination means will travel together with the passenger. The respective passenger detecting device may just detect the passenger at the entry to the people conveyor. It can also be a device which extends along the length of the people conveyor and which can detect the actual position of the passenger on the step. Particularly in case with the detection of the passenger is performed only at the entrance, the illumination spot can extend forward from the passenger a distance which is larger than the average distance walked by a walking passenger on the people conveyor.

The people conveyor can comprise a bus system connecting individual illumination sources with the illumination control. The bus system can comprise an address bus, a data line and power lines for supplying the power to the individual light sources. Preferably, the illumination control includes the power supply to the individual light sources. The illumination control can be connected to the conventional controller of the people conveyor which controls operation thereof. This conventional control can also provide the information on the handrail speed or the conveyor band speed to the illumination control. The device for determining the speed of the transportation band and/or handrail can be connected to the illumination control and can be an encoder connected to the driving shaft thereof, it can be any sensor adapted to measure the speed of the transportation band directly at the transportation band (or handrail, respectively) or at the drive or drive motor thereof. Alternatively, the device may also be the control which controls the drive motor of the people conveyor, thus providing the speed based on the rotational speed of the motor and the control commands to the motor, respectively. The illumination control can comprise a conveyor band speed memory for providing the transportation band speed reference. The memory can be connected to the speed determining device and be updated in certain intervals. It can also be programmed and adjusted manually in the factory and/or during maintenance.

The illumination sources can comprise at least one LED (light emitting diode). The same can be a white light LED, a particular colour LED (for example otis blue) or a combination of red, green and blue LEDs (RGB-LEDs). The latter allow to more or less generate each colour.

The LEDs can be arranged in a chain one after the other so as to form a flexible illumination hose. The LEDs may just be connected and supported by the bus cable. Alternatively, they may be supported by any supporting material. The illumination means can be positioned in an illumination cavity or illumination channel. The illumination means can be fixed therein by any fastening means like snap-on elements, clips, etc. similar to those as used with conventional illumination tubes.

The illumination cavity can be covered by glass or any other transparent material. It is preferably covered by a diffuser, for example a flat transparent material having a frosted surface (preferably the surface facing the illumination means) which allows for an even distribution of the light of the diffuser surface.

The illumination means can be arranged in an illumination cavity in an inner decking for illumination of the transport band. It is understood that the illumination cavity may be located at any location along the inner decking, including the vertical part of the inner decking, which is adjacent to the skirt panel. The illumination means can also be arranged in a profile which supports the handrail. Moreover, the illumination means can be arranged so as to radiate into a glass balustrade. The illumination means does not necessarily have to illuminate the transportation side of the people conveyor but can also illuminate the outside thereof. The illumination means can thus be used for informing potential uses of the movement direction of the people conveyor for example by a moving gap or moving spot.

The illumination means can also be arranged in a separate lighting profile which can be attached to the inner or outer decking of a people conveyor. Such lighting profile can easily be retrofitted on existing people conveyors by means of fasteners like screws or adhesive, etc. The lighting profile can be attached to at least one of the decking and the balustrade.

Preferably, the balustrade is transparent and an illumination cavity of the lighting profile and the illumination means therein are positioned so that in use the illumination means radiates into and through the balustrade. It is possible to radiate approximately perpendicular to the surface of the balustrade into the glass balustrade. It is also possible to arrange the illumination means so that is radiates with an angle between 0 and 90°, preferably between 10 and 80° and most preferred between 30 and 60° to the glass balustrade. Preferably, the direction of the light is upward from the decking, i.e. towards the handrail which typically is arranged on top of the glass balustrade.

Preferably, an illumination cavity and an illumination means of the lighting profile are arranged so that in use the illumination means radiates towards the transportation band of the people conveyor. It has already been mentioned that for security reasons it is preferred to illuminate the transportation band particularly in the entrance area and the exit area, but it can also be preferred to illuminate the complete length of the transportation band or sections between the entrance area and the exit area. In order to enhance the intensity of the illumination it is possible to use a mirror means within the illumination cavity and it is also possible to use lens means focussing the light.

Preferably, the lighting profile comprises two attachment surfaces which are adapted to be attached to the decking and the balustrade, respectively and particularly to the inner decking and the balustrade, respectively. In a corner between the balustrade and the decking, there is sufficient space for housing the light profile. Moreover, the lighting profile can snuggly fit into this corner so that it is not easy to intentionally break the lighting profile loose. It is preferred to fix the profile onto the decking with fixing means, like screws, bolts, rivets or alternatively with adhesive material and it can be sufficient to fix the illumination profile only to the decking but not to the glass balustrade. If the balustrade is made of material different from glass, and particularly if it is not a transparent or translucent balustrade, it may also be attached to the balustrade by screws, bolts, and rivets, etc. If the lighting profile is also to be fixed to the glass balustrade, adhesive materials are preferred. Preferably, a sealing is provided between the lighting profile and the balustrade. The lighting profile is preferably attached so as to have the sealing biased between the balustrade and the lighting profile. Thus, entrance of dust and dirt into the gap between the lighting profile and the balustrade is avoided.

Preferably, the lighting profile is made from an extruded material. Extrusion of the lighting profile is preferred due to the relatively low cost for extruded profiles. Different materials can be used for the lighting profile. Thus it is possible to use transparent or translucent material. It is also possible to use metal, like aluminum and aluminum alloys for the lighting profile. Such aluminum material is preferred due to the relatively low weight thereof as well as the sufficient rigidity thereof so that the lighting profile made of such material cannot break easily. In order to enhance the dissipation of heat generated by the illumination means it is preferred to use a material which has a high coefficient of thermal conductivity, like metal and particularly the aluminum materials as mentioned above.

Preferably, an illumination cavity is open towards the attachment surface which is in use in abutment with the glass balustrade. Thus, the illumination cavity forms an illumination channel which is running along the balustrade attachment surface and no cover for covering the illumination means is required.

Instead of fastening the LED chain by mechanical means into the illumination cavity, a potting material can beused for mounting the LEDs into the illumination cavity. Preferably the potting material is in the hardened condition, any kind of plastics material. It may be a flexible material which allows easy installation of the potted LEDs into the lighting profile and facilities flexing of the lighting profile with the installed LEDs. For example an epoxy resin can be used. Generally it is an advantage of the potting material to position the LEDs securely within the illumination cavity, since securely positioned LEDs facilitate the assembly. Moreover, by using the potting material the LEDs are fixed in place so that the illumination direction thereof will be maintained. It is possible to pot the LEDs in the potting material outside the body of the lighting profile and to assemble this potted illumination band into the body only thereafter. In this case a flexible potting material is particularly preferred. It is also possible to provide a support, for example an U-shaped channel made from metal, aluminium, plastics material, etc., supporting the LEDs and the potting material, forming together with the LEDs, and the potting material an illumination band. Such illumination band can be mounted into the lighting profile. In many cases, however, it may be preferred to first place the LEDs into the illumination cavity in the body of the lighting profile and then pour the potting material around the LEDs and let the potting material cure. This latter method insures a good connection between the potting material and the material of the body of the lighting profile so that different thermal expansion coefficients will not cause the illumination means to separate from the illumination cavity easily. Preferably, the potting material is transparent or translucent. By using a transparent or translucent potting material it is possible to completely enclose the LEDs within the potting material. It may also be preferred not to completely enclose the LEDs within the potting material but to have the illuminating side of the LEDs extending out from the potting material. In this case there is no need to use a transparent potting material.

Preferably, the potting material has a good coefficient of thermal conductivity. Such potting material ensures a good dissipation of heat as produced by the LEDs or any other illumination means into the profile material and away from the illumination cavity.

Preferably, at least a portion of the LEDs is supported on a common printed circuit board. The printed circuit board is preferably flexible so as to allow conformity of the printed circuit board with a bent profile and in order to allow for an easy assembly thereof. Particularly, the LEDs and any other components can be mounted to the surface of the printed circuit board by means of the surface mount technology. The printed circuit board can include the conductors for feeding the LEDs; it can also include data lines, for example the data bus of the bus system and can further include logic elements to be used with respect to each individual LED or groups of individual LEDs together with the bus system. Such logic elements can also be surface-mounted to the flexible printed circuit board. The potting material can also pot the flexible circuit board together with the components mounted thereon in order to protect the components and the printed circuit board.

The lighting profile can either extend along the complete length of the people conveyor to be illuminated or it can be made up from a plurality of individual lighting profile segments which are adjoined with each other in the longitudinal direction of the profile and which preferably have electrical connectors provided at longitudinal ends of the profile segments for electrically connecting the profile segments with each other. In order to increase the integrity of the individual profile segments, overlapping areas can be provided, like an overlapping extension on the outer surface of one profile which overlaps a corresponding recess on the adjacent profile. Additionally or alternatively, a groove and tongue means or any similar engagement means can be provided at adjacent ends of lighting profile segments. Preferably, the LEDs of one profile segment are mounted on a common printed circuit board.

Preferably, the lighting profile comprises fins or ribs for increasing heat dissipation. Such fins or ribs can be provided at the outer side of the profile, i.e. the side facing the environment. They can also be provided within the illumination cavity in order to increase the heat dissipation from the LEDs into the material of the profile. Even if a thermally conductive potting material is used, such internal fins or ribs can be provided in order to improve the heat transfer from the potting material to the profile material and in order to enhance the engagement of the potting material with the profile material.

Where the illumination means is provided in a profile for engaging the glass balustrade which profile comprises an illumination cavity, the profile can comprise an U-shaped channel for attaching it to the upper side of the balustrade and the illumination cavity can be an extension of the U-shaped channel so that the illumination means radiate through the edge or face of the glass balustrade into the interior of the transparent material.

Alternatively, the profile can be made of a transparent or translucent material and the illumination cavity can be provided separately from the U-shaped channel engaging the glass balustrade. If, however, the illumination cavity is an extension of the U-shaped channel so that the LEDs are in direct optical contact with the glass balustrade, the profile can be made from a material having a good thermal conductivity, for example metal material, and preferably an aluminium or aluminium alloy. Despite that fact that LEDs produce only small amounts of heat, they produce heat which needs to be dissipated. Transparent profiles as mentioned above are made of resin material which typically is not a good thermal conductor. If LEDs are used in a illumination cavity in such a resin profile, and if no means for dissipating thermal energy are provided, the LEDs have to operate at elevated temperatures which might cause premature failure of the LEDs. The use of the LEDs in combination with a profile made from a material having a good thermal conductivity insures good thermal dissipation and reasonable operating temperatures for the LEDs.

Again, a potting material can be used for mounting the LEDs into the illumination cavity. Preferably, the U-shaped channel has a depth direction which is defined in parallel to lateral walls of the U-shaped channel in the direction from the open mouth to the base of the U, wherein the illumination cavity is an extension of the U-shaped channel in the depth direction. Using such profile shape, the LEDs can be placed and potted, respectively, in the profile with the illumination side thereof opposite to the peripheral front face of the glass balustrade. Moreover, the manufacturing of such an illumination is very simple because the LEDs can be easily mounted in such an enlarged channel.

Preferably, the U-shaped channel has a depth direction which is defined in parallel to the lateral walls of the U-shaped channel in the direction from the open mouth to the base of the U, and wherein the illumination cavity is an extension of the U-shaped channel in one of the lateral walls thereof and perpendicular to the depth direction. This construction brings the illuminating side of the LEDs into an opposed position with respect to one of the lateral surfaces of the glass panel. It is possible to angle the LEDs and possibly also the illumination cavity with respect to the depth direction of the U-shaped channel and the plane of the glass balustrade, respectively, so as to let the LEDs radiate into the glass panel with an angle between 0° and 90°, preferably between 10° and 80° and most preferred between 30° and 60° with respect to a plane of the glass panel.

Preferably, an elastic interlayer is provided between the profile and the glass balustrade along the lateral walls of the U-shaped channel and, preferably, such an interlayer is also provided between walls of the illumination cavity and the LEDs. By using such a construction, the mounting of the LEDs into the illumination cavity and particularly the potting of the LEDs therein can be used for securing such elastic interlayer within the profile. It is possible to use a translucent or transparent elastic interlayer. There is no need to provide such an interlayer between the walls of the illumination cavity and the LEDs, but it can be provided between the LEDs and the glass balustrade.

Preferably, the profile is screwed to the glass profile by means of a plurality of screws. With existing constructions the profile is fixed to the balustrade by way of spring means which are biased against the glass balustrade for fixing the profile thereon. Spring means are not easy to manufacture and to install. Typically, such spring means have to be customised for the particular application so that there are relatively expensive components. Screws can be taken from stock and are relatively inexpensive compared to such spring means.

Preferably, the profile is attached on top of the glass balustrade and forms a guide support for the handrail.

Preferably, the profile is attached to a base structure of the people conveyor and supports the glass balustrade. By using the profiles according to the present invention for supporting the glass balustrade and for supporting the handrail, illumination for the glass balustrade can be provided from the top and from the bottom so that a very high illumination intensity and equal intensity distribution over the glass balustrade can be realized.

Preferably, means for electrostatic grounding of the handrail are provided. The moving handrail is typically made of an elastomeric material which is subjected to electrostatic charging thereof. In the effect, very high voltages can be generated which might destroy the LEDs. In order to ensure prolonged lifetime of the LEDs an electrostatic grounding is preferred together with the LED illumination.

Preferably, at least a portion of the LEDs is supported on a common printed circuit board. The printed circuit board is preferably flexible. Particularly, the LEDs can be surface mounted to the printed circuit board. The printed circuit board can include the conductors for feeding the LEDs. It can further comprise data lines, for example the data bus of the bus system, and can further include logic elements to be used with respect to each individual LED or groups of individual LEDs together with the bus system.

Preferably, the profile of the people conveyor is formed of a plurality of profile segments which are joined with each other in longitudinal direction of the profile and which preferably have electrical connectors provided at longitudinal ends of the profile segments for electrically connecting the profile segments with each other. Preferably, the LEDs of one profile segment are mounted on a common printed circuit board.

Preferably, the profile and the profile segment, respectively, comprise fins or ribs for increasing heat dissipation. Such fins or ribs can be provided at the outer side of the profile, i.e. the side facing the environment. They can also be provided within the illumination channel in order to increase the heat dissipation from the LEDs into the material of the profile. Even if a thermal conductive potting material is used, such internal fins or ribs can be provided in order to improve the heat transfer from the potting material to the profile material.

Embodiments of the invention are described in greater detail below with reference to the Figures, wherein:

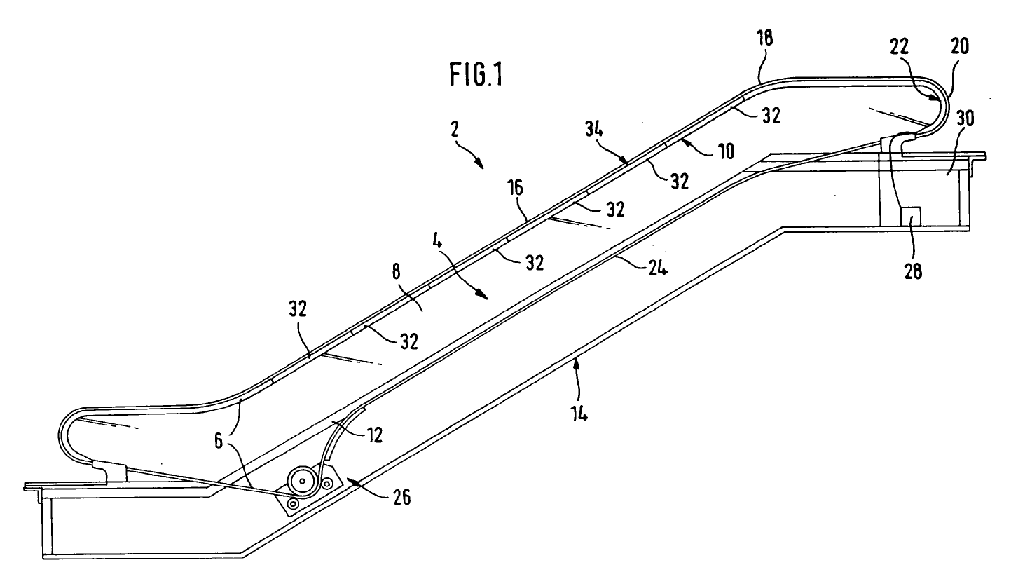

FIG. 1 shows a people conveyor having an illumination in accordance with an embodiment of the present invention;

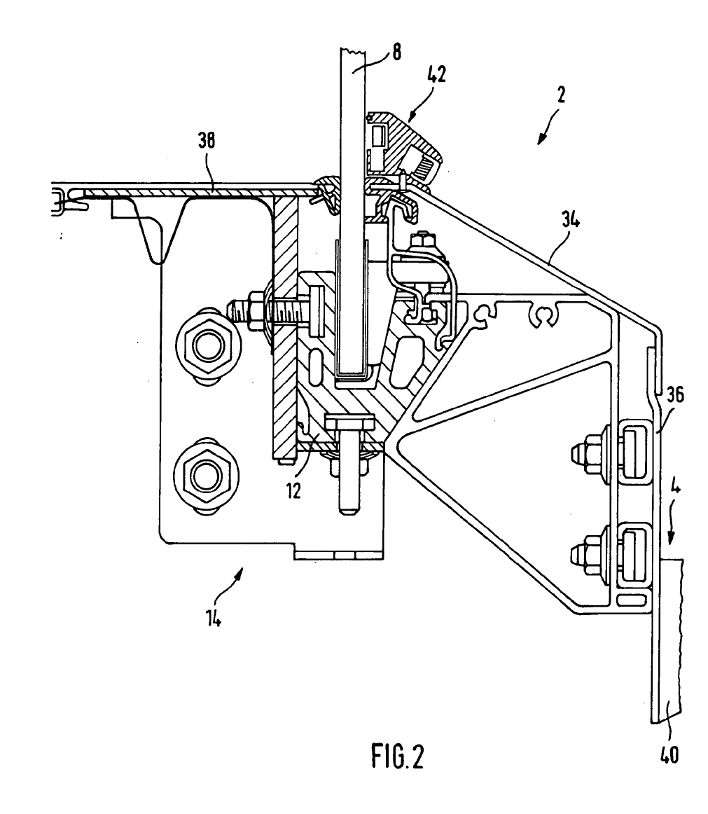

FIG. 2 is a cross sectional view of the people conveyor with the lighting profile in accordance with an embodiment of the present invention; and

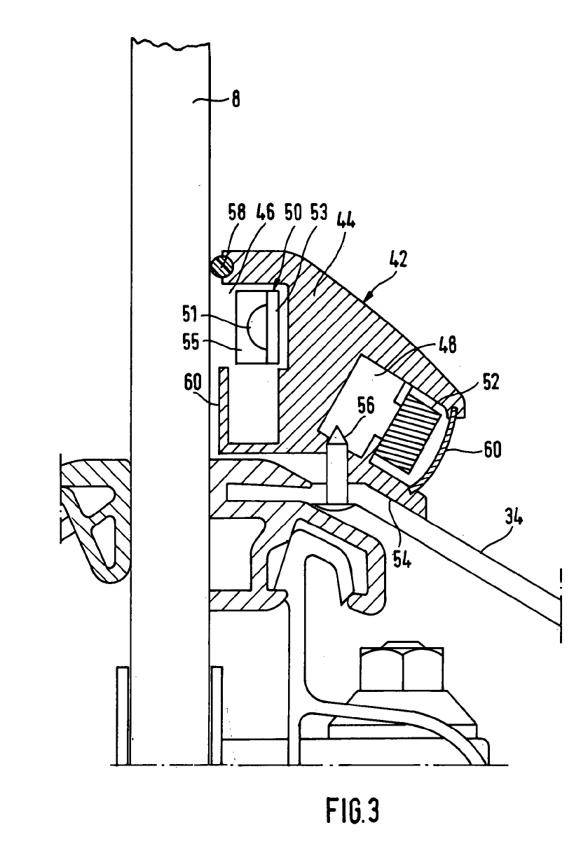

FIG. 3 is an enlarged sectional view of the lighting profile.

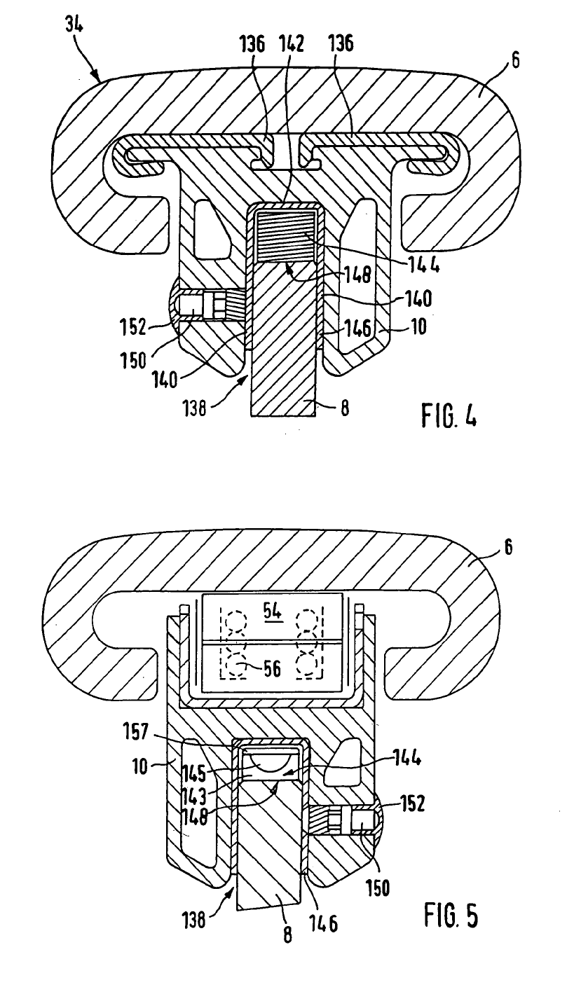

FIG. 4 is a cross sectional view of a profile supporting the handrail of the people conveyor and part of the glass balustrade in the inclined area of the people conveyor and housing another illumination means; and

FIG. 5 shows a sectional view similar to that of FIG. 4 of the profile in the newel bow of the people conveyor.

FIG. 1 shows a people conveyor 2 in accordance with an embodiment of the present invention. Particularly, the people conveyor 2 of FIG. 1 is an escalator, but the invention can also be realized with a moving walkway, etc. The respective features as described with respect to the escalator can also be present with the illumination system in any other people conveyor.

The people conveyor 2 has an endless people transportation band 4 made up from a plurality of steps which are arranged one next to the other. The people conveyor 2 further includes a handrail arrangement 34 comprising an endless handrail 6 moving in parallel with the people transportation band 4. A glass balustrade 8 is arranged laterally to the transportation band 4 and supports the handrail 6. Particularly, the handrail 6 is supported by a handrail support profile 10 which is mounted on top of the glass balustrade 8. Similar to the handrail support profile 10 there is a balustrade support profile 12 which is supported by a base structure 14 of the people conveyor 2 and which supports the glass balustrade 8 from below.

As will be discussed in detail below, the glass balustrade 8 and/or the people transportation band 4 can be illuminated by an illumination means. The glass balustrade 8 can be structured in way so as to scatter the light out of the volume of the glass balustrade 8 in order to provide illumination for the people conveyor or in order to display information. It is possible to have such structures only in particular areas, for example in the form of an image or word which is to be displayed. But it is also possible to have such structure on the complete side surface of both side surfaces of the glass balustrade. The structure can be produced by various techniques, for example blasting techniques like grid blasting or sand blasting. It is also possible to print such structures on the surface. Screen printing and particularly screen printing of ceramic material is most preferred at present.

As can be seen in FIG. 1, the handrail follows an endless path through an inclined area 16, a transition area 18, a newel area 20, where the handrail is guided around a newel bow 22, and then through a return path 24. In the return path a handrail drive 26 is arranged. An illumination control 28 for controlling and providing power for the illumination means 50, 52 can be positioned in space 30 below the upper landing or at any other place within the people conveyor 2 or even outside thereof. The illumination control 28 can also include control means like a microprocessor, etc. for controlling the illumination. The illumination control 28 can also be positioned separately from the power source. The handrail support profile is made of a plurality of profile segments 32 which are adjacent to each other in the longitudinal direction of the handrail support profile 10. Similarly, the balustrade support profile 12 is made of a plurality of profile segments.

FIG. 2 is a sectional view of a portion of the people conveyor 2. The sectional view of FIG. 2 shows how the glass balustrade 8 is supported by the glass balustrade support profile 12 on the base structure 14 of the people conveyor. The exterior fairing of the people conveyor 2 is formed from the inner decking 34, the skirt panel 36 and the outer decking 38. The skirt panel 36 is adjacent to the people transportation band 4 and particularly to the individual steps 40. A lighting profile 42 is attached to the inner decking 34. In addition, while the lighting means is illustrated as being located in a lighting profile on top of the inner decking near the balustrade 8, the lighting means can be located anywhere along the inner decking 34, including the vertical portion of the inner decking 34, which is adjacent to the skirt panel 36. Also, the lighting means may be set within a channel of the inner decking 34 so that the lighting means and a respective transparent or translucent cover, respectively, is approximately flush with the surface of the inner decking 34.

As can be seen in FIG. 3, the lighting profile 42 comprises a body 44 and two illumination cavities 46 and 48 and particularly a balustrade illumination cavity 46 and a transportation band illumination cavity 48. In each illumination cavity 46, 48 at least one illumination means 50, 52 is provided. It is to be noted that a single illumination means as well as a single illumination cavity can be provided for illuminating both the transportation band 4 and the balustrade 8.

The illumination means 50, 52 can include a plurality of LEDs 51 which are surface mounted to a flexible printed circuit board 53 comprising the wiring for the LEDs 51 and particularly comprising a bus system for individually switching LEDs 51 on and off. Control components which switch individual LEDs 51 or groups of LEDs in correspondence with data for example from the bus system can also be mounted on the printed circuit board 53. Particular a data decoder and an associated switching means which is connected to the power line and the respective LED(s) can form a control component. Any other circuitry or conductor arrangement can be used for individually or groupwise switching LEDs 51 on and off. The printed circuit board, the LEDs, and the components on the printed circuit board 53 can be potted in a potting material 55. Preferably, the potting material 55 is a thermally conductive material, and preferably such potting material is in intimate contact with the material of the body 44 of the lighting profile in order to dissipate the heat as generated by the illumination means 50, 52. The LEDs are preferably those as sold by the German company Osram under the name of LBE67C POWER TOPLED or LT E67C.

A further option for reducing the temperature as generated by the illumination in the lighting profile 42, a conductor having a relatively large cross sectional area can be used for supplying power to the individual LEDs 51. A wire of the type lapp canel, oelflid 191,3G 1,5 mm/16AWG has been found suitable. A power supply can be provided for supplying power to the LEDs 51 and for controlling the illumination (color, intensity, etc.) of the LEDs 51. If a plurality of stairs needs to be controlled, for example in unison within a building, one power supply can be configured as Master controller. The Master controller or any other power supply can control the colors via preset values or a PC program, static or dynamic.

The lighting profile 42 has an attachment surface 54 for attaching it to the inner decking 34. A fastener 56 is used for fixing the body 44 of the lighting profile 42 to the inner decking 34. In the present embodiment such fastener 56 is a screw engaging the body 44. In order to facilitate the attachment of the lighting profile 42 an extruded lighting profile 42 can include a screw slit which is formed during the extrusion of the lighting profile 42. Thus the fastener 56 can be positioned at any place along the length of the lighting profile 42.

A sealing 58 is provided at the attachment surface 60 facing the balustrade 8. As can be seen, the attachment surface 60 is not in contact with the balustrade 8, but only the sealing 58 is in contact with the balustrade 8. This avoids scratching, etc. on the glass surface of the glass balustrade 8. Preferably, the sealing 58 is elastically biased against the glass balustrade 8. The illumination cavity 46 has no cover towards the glass balustrade 8, thus allowing optimum transmission of the light generated by the illumination means 50 in circuit glass balustrade 8. The illumination cavity 48 is covered by a transparent or translucent cover 60. The cover 60 can be of the lens type in order to focus the light towards the transportation band 4.

The attachment surface 54 of the body 44 is in intimate contact, preferably over a large surface area, with the outer surface of the inner decking 34 in order to provide for a good heat dissipation from the body 44 to the structure of the people conveyor.

Like the individual handrail support profile sections 32, a plurality of lighting profile sections can form the lighting profile 42. The power source 28 can be positioned as shown in FIG. 1, but it is also possible to house the power source within the lighting profile 42 and particularly within an illumination cavity 46, 48. Electrical connection can be made through an opening in the inner decking and the screw slit in the profile or even through a hollow fastener 56, or through any other opening in the profile and/or the decking.

FIG. 4 is a section through the handrail arrangement 34 at any location of the handrail arrangement except the newel area 20 and the return path 24. As can be seen in FIG. 4, the handrail arrangement 34 comprises the handrail 6, made of an elastic rubber material as it is conventional, a sliding guide 136 which is supported by the profile 10. The profile 10 has a U-shaped channel 138 comprising lateral walls 140. The U of the U-shaped channel 138 is opening downwardly in the representation of FIG. 4 and has a base 142.

It is to be noted that the profile 12 also comprises a U-shaped channel and is in some respect similar to the profile 10. The profile 12 does not necessarily have any means for guiding the handrail 6. The profiles 10 and 12 are preferably made of a material having a good thermal conductivity, for example a metal, etc. Preferably, the profiles 10, 12 are extruded aluminium or aluminium alloy profiles. An illumination cavity 144 is provided in the extension of the U-shaped profile 138. A plurality of LEDs 145 is arranged in the illumination cavity 144. The LEDs are preferably those as sold by the German company Osram under the name of LBE67C POWER TOPLED or LT E67C. A potting material 143 is used for mounting the LEDs 145 into the illumination cavity. An elastic interlayer 146 is provided between the profile 10 and the glass balustrade 8. As can be seen in FIG. 2, the elastic interlayer 146 is provided along the lateral walls 140 of the U-shaped channel 138 and is also provided along the walls of the illumination cavity. In order to provide for a good thermal contact between the LEDs and the profile 10 and particularly between the potting material and the profile 10, it is possible to provide openings in the elastic interlayers 146 at least in the area of the illumination cavity in order to make sure that any heat developed by the LEDs, etc., will be dissipated through the interlayer 144 and into the profile 10.

A further option for reducing the temperature as generated by the illumination in the lighting profile 142, a conductor having a relatively large cross sectional area can be used for supplying power to the individual LEDs 151. A power supply can be provided for supplying power to the LEDs 151 and for controlling the illumination colour, intensity, etc.) of the LEDs 151. If a plurality of stairs needs to be controlled, for example in unison within a building, one power supply can be configured as Master controller. The Master controller or any other power supply can control the colours via pre-set values or a PC program, static or dynamic.

In the representation of FIG. 4, the light as generated by the LEDs is directed through an edge or peripheral front surface 148 of the balustrade 8 into the volume of the balustrade 8.

The glass balustrade has a typical width of 10 mm. Preferably, the illumination band as formed by the LEDs has substantially the same width as the glass balustrade.

The profile 10 is fixed to the glass balustrade 8 by way of screws 150 and preferably by way of self-cutting headless screws 150. The screw opening may be covered by cover 152.

FIG. 5 is a sectional view similar to that of FIG. 4, but is taken in the area of the newel bow 22. In order to reduce friction between the handrail 6 and the newel bow 22, rollers 154 are journaled in the profile 10. Particularly, such rollers can be made of metallic material, for example copper, and it is possibile to ground such rollers in order to avoid electrostatic charging of the handrail 6. Roller bearings 156 are schematically shown within the envelope of the roller 154.

The LEDs 145 are preferably mounted to a flexible printed circuit board 157 which extends along the length of the illumination cavity 144. A data bus can be provided on such printed circuit board 157 or separately therefrom in addition to the conductors feeding electrical power to the LEDs 145. The data bus can be connected with individual LEDs 145 and/or groups of LEDs 145 in order to separately illuminate such individual LEDs 145 or groups of LEDs 145. To this effect, for each individual LED 145 or for each group of LEDs 145 a data decoder is provided. The data decoder can be integrally formed on the printed circuit board or can be integrally formed with the LED 145, but can also be surface mounted to the printed circuit board or be individually connected with the data bus and the LED(s) 145. Associated to the data decoder a switching means can be provided for switching power to the respective LED 145 or groups of LEDs 145 in case that the information on the data bus requires illumination thereof. Any other circuitry or conductor arrangement can be used for individually or groupwise switching LEDs 145 on and off.

By using such individual or groupwise controller of the LEDs 145, it is possible to have localised illumination on the glass balustrade 8 or illumination which moves along the glass balustrade 8, for example in unison with the movement of a passenger standing on the transportation band 4, etc.

In another alternative embodiment, the illumination means can place in the profile 10 supporting the handrail 10 and/or the profile 12 supporting the balustrade 8, which both can be made up from a plurality of profile segments 32, which are adjacent to each other in the longitudinal direction of the profile 10.

1. People conveyor (2) having an endless people transportation band (4) and an endless handrail (6), a device ( ) for determining the speed of the transportation band (4) and/or the endless handrail (6), an illumination means (50, 52) extending along the transportation band (4) and comprising a plurality of illumination sources (51), and an illumination control device (28) connected to the illumination sources (51), wherein the illumination control device is adapted to effect illumination of individual illumination sources (51) dependent of the speed of the transportation band (4) and/or the handrail (6).

2. People conveyor (2) according to claim 1, wherein the illumination control device (28) is adapted to effect illumination of individual illumination sources (51) so that an “illumination gap” travels along the illumination means (50, 52) together with the transportation band (4).

3. People conveyor (2) according to claim 1 or 2, further comprising a passenger detecting device which is connected to the illumination control (28) and wherein the illumination control (28) is adapted to effect illumination of the individual illumination sources (51) so that an illuminated portion of the illumination means (50, 52) travels together with the passenger.

4. People conveyor (2) according to any of claims 1 to 3, further comprising a bus system connecting individual illumination sources (51) with the illumination control (28).

5. People conveyor (2) according to claim 4, wherein the bus system further includes the power supply to the individual illumination sources (51).

6. People conveyor (2) according to any of claims 1 to 5, wherein the illumination sources comprises at least one LED (51).

7. People conveyor (2) according claim 6, wherein the LEDs (51) are arranged in a chain one after the other so as to form a flexible illumination hose.

8. People conveyor (2) according to claim 6 or 7, wherein the LEDs (51) comprise LEDs (51) of different colours.

9. People conveyor (2) according to any of claims 1 to 8, wherein the illumination means (50, 52) is arranged in an illumination cavity in an inner decking for illumination of the transportation band (4).

10. People conveyor (2) according to any of claims 1 to 8, wherein the illumination means (50, 52) is arranged in a lighting profile (42) attached to the decking (34, 38).

11. People conveyor (2) according to any of claims 1 to 8, wherein the illumination means (50, 52) is arranged in a profile ( ) which supports the handrail (6).

12. People conveyor (2) according to any of claims 1 to 8, further comprising a glass balustrade (8) and wherein the illumination means (50, 52) is attached so as to radiate light into the glass balustrade.

13. People conveyor (2) according to any of claims 1 to 12, wherein the illumination control device (28) comprises a conveyor band speed memory.

14. People conveyor (2) according to any of claims 1 to 12, wherein the illumination control device (28) is connected with the speed determining device.
